(19) United States
(12) Patent Application Publication
(10) Pub. No.: US 2003/0046699 A1
(43) Pub. Date: Mar. 6, 2003

(54) Digital broadcasting receiver

(76) Inventors: Takaya Nonomura, Osaka (JP); Kiyoshi Matsumoto, Osaka (JP); Masako Wakisaka, Osaka (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/234,383

(22) Filed: Sep. 5, 2002

(30) Foreign Application Priority Data
Sep. 6, 2001 (JP) 270327/2001

(51) Int. Cl. G06F 3/00; H04N 5/445; G06F 13/00

(52) U.S. Cl. 725/58; 725/39; 725/46; 725/40

(57) ABSTRACT

A digital broadcasting receiver judges, when a program is reserved by a user on a program guide table, whether or not the reserved program should be in a series, to prompt, when the reserved program is in the series, the user to choose whether or not the reserved program should be registered as a series reservation, and extracts, when it is chosen that the reserved program should be registered as a series reservation, programs which are in a series relationship with the reserved program, to process the programs constituting the series as reserved programs.

### BACKGROUND OF THE INVENTION

1. Field of the Invention

The present invention relates to a digital broadcasting receiver that receives satellite digital broadcasting and terrestrial wave digital broadcasting. The digital broadcasting receiver that receives digital broadcasting using a satellite or a terrestrial wave selects any of a plurality of broadcasting waves received through a dedicated antenna or a terrestrial wave antenna using a tuner, selects any of a plurality of channels included in the selected broadcasting wave using demultiplex processing, extracts a digital signal on the selected channel, and decodes the extracted digital signal, to output a video/audio signal.

In such digital broadcasting, program information is also transmitted besides transmitting video or audio, as in conventional analog broadcasting. The program information includes various information such as the name of a program, the time when the program begins, a time period during which the program is continued, and the contents of the program. It is possible to select a program desired by a user from multichannel broadcasting by an EPG (Electronic Program Guide) display function using an OSD (On-Screen Display) function on the side of the receiver. Further, a program which is scheduled to be broadcast can be selected on an EPG using the EPG display function, to reserve viewing and recording.

The above-mentioned program information includes a series descriptor (series_id, episode_number, etc.), and a series (e.g., a drama series) can be retrieved on the basis of the series descriptor. Therefore, it is requested to provide added convenience to a user using the series descriptor.

An object of the present invention is to provide a digital broadcasting receiver which can provide convenience to a user by performing various types of processing using series as an object.

### SUMMARY OF THE INVENTION

In order to solve the above-mentioned problem, a digital broadcasting receiver according to the present invention is characterized by comprising means for extracting program information included in a digital broadcasting wave; means for outputting a program guide table on the basis of the program information; means for judging, when a program is reserved by a user on the program guide table, whether or not the reserved program is in a series on the basis of the program information, to prompt, when the reserved program is in the series, the user to choose whether or not the reserved program should be registered as a series reservation; and means for extracting, when it is chosen that the reserved program should be registered as a series reservation, programs which are in a series relationship with the reserved program on the basis of the program information, to process the programs constituting the series as reserved programs.

In the above-mentioned configuration, when the user reserves the program on the program guide table, the user can know, if the reserved program is in the series, that the reserved program is in the series. If the user desires not to forget to view the programs which will be broadcast after this as the series, the desire can be easily realized by selecting the series reservation.

The digital broadcasting receiver may be so configured that a list of reserved programs can be displayed, to display a note meaning a series on a display area of the program constituting the series on the list of reserved programs. Consequently, it is possible to know whether or not the reserved program is in the series at a glance.

The digital broadcasting receiver may be so configured that a list of reserved programs can be displayed, to handle, when reservation cancellation processing of the program constituting the series is performed on the list of reserved programs, the reservation cancellation processing as cancellation of only the program constituting the series, record that the program constituting the series is canceled without being deleted as data related to the series, and display on the list of reserved programs a note meaning that a program has been canceled. Consequently, it is possible to prevent the reservation of the program whose reservation has been canceled from being registered again in the case of re-retrieval by recording that the program constituting the series is canceled without being deleted as data, as described above. Further, the note meaning that a program has been canceled is displayed on the list of reserved programs, thereby making it possible for the user to confirm on the list of reserved programs that the program constituting the series has been canceled.

The digital broadcasting receiver may be so configured that a list of series reservations using only series as an object can be displayed.

In such a configuration, when the series is selected on the list of series reservations, an explanatory note based on information acquired from the program information may be displayed with respect to the series.

When the series is selected on the list of series reservations to perform a predetermined operation, the list of reserved programs comprising the programs constituting the series may be displayed.

Furthermore, when reservation cancellation processing of the series is performed on the list of series reservations, the processing may be performed as reservation cancellation of all the programs constituting the series.

It may be judged whether or not another program which is overlapped with the air time of the program constituting the series, which has been reserved as a series, has already been reserved, to display, when it is judged that the program has been reserved in an overlapped state, a note meaning overlapping in the display area of the program constituting the series on the list of reserved programs.

Processing for retrieving the program constituting the series from the program information again may be repeatedly performed at regular or irregular intervals.

In such a configuration, when the program constituting the series, which is an object to be reserved, is deleted from a schedule of broadcasting before the reservation thereof is executed, the reservation of the program constituting the series is not executed, to display a note meaning that a schedule of broadcasting is deleted before the reservation is executed in the display area of the program constituting the series on the list of reserved programs.

Furthermore, processing for retrieving the program constituting the series from the program information again may be repeatedly performed at regular or irregular intervals, to register, when the overlapped state is solved in the re-retrieval, the reservation of the program constituting the series as well as to delete the note meaning overlapping from the display area of the program constituting the series on the list of reserved programs.

Furthermore, processing for retrieving the program constituting the series from the program information again may be performed at least once per day.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a digital broadcasting receiver 30 according to the present embodiment;

FIG. 2 is an explanatory view showing an EPG screen;

FIG. 3 is an explanatory view showing the transition of a screen at the time of reserving a series;

FIG. 4 illustrates an EPG screen after reserving a program;

FIG. 5 is a flow chart showing processing for retrieving a series again;

FIG. 6 (a) and FIG. 6 (b) are explanatory views respectively showing a menu screen and a reserved program list screen;

FIG. 7 (a) and FIG. 7 (b) are explanatory views respectively showing a series reservation list screen and a reserved program list screen comprising programs constituting a series.

### DESCRIPTION OF THE PREFERRED EMBODIMENTS

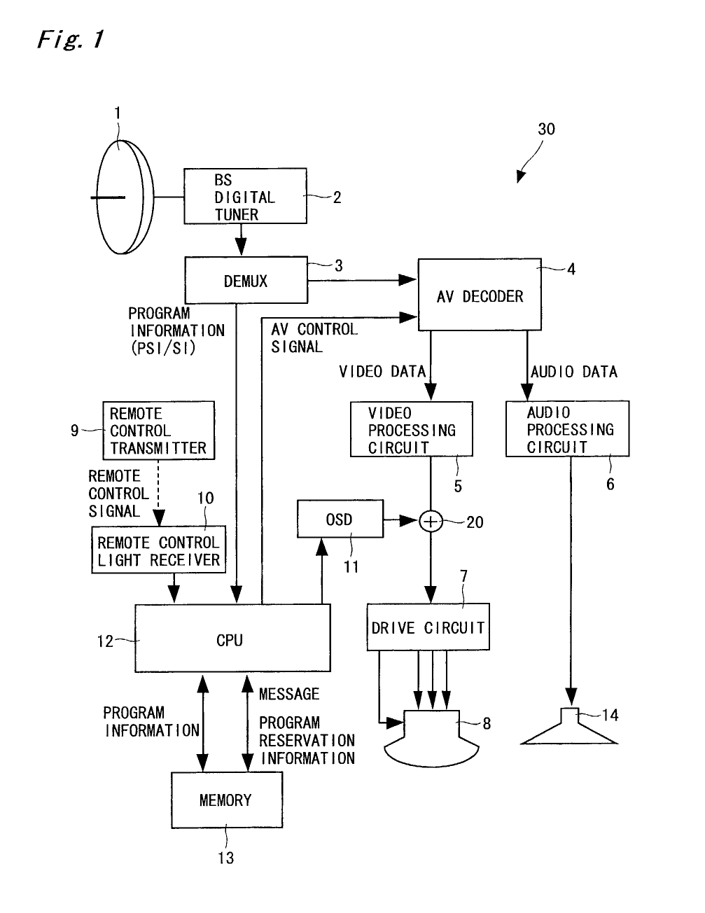

An embodiment of the present invention will be described on the basis of FIGS. 1 to 7. Here, a case where a user views BS (Broadcasting Satellite) digital broadcasting is illustrated.

In FIG. 1, an antenna 1 is arranged in a predetermined direction outdoors, and receives a digital broadcasting wave fed from a BS. The antenna 1 generally comprises a frequency converter, and feeds a received/frequency-converted signal to a BS digital tuner 2.

The BS digital tuner 2 extracts, out of received high-frequency digital modulation signals, the signal having a particular frequency. That is, it performs processing for selecting one of a plurality of transponders for digital broadcasting. Further, the BS digital tuner 2 comprises a demodulation circuit, an inverse interleave circuit, an error correcting circuit, and so forth, thereby demodulating the selected digital modulation signal and outputting a transport stream.

A demultiplexer (DEMUX) 3 separates the transport stream received from the tuner 2 into a video stream and an audio stream based on MPEG2 (Moving Picture Experts Group2) and PSI/SI (Program Specific Information/Service Information). The demultiplexer 3 feeds the video stream and the audio stream to an AV decoder 4, and feeds to a CPU 12 program information (the name of a program, the time when the program begins, a time period during which the program is continued, a series descriptor, etc.), for example, included in the above-mentioned PSI/SI. As described above, a plurality of channels are multiplexed on the transport stream. Processing for selecting any of the channels can be performed by taking out from the PSI data indicating which packet ID in the transport stream is used to multiplex the arbitrary channel. The selection of the transport stream (the selection of the transponder) can be made on the basis of the PSI/SI.

The AV decoder 4 comprises a video decoder for decoding the video stream and an audio decoder for decoding the audio stream. The video decoder decodes an entered variable length code to find a quantization factor and a motion vector, thereby carrying out inverse DCT (Discrete Cosine Transformation), motion compensation control based on the motion vector, and the like. The audio decoder decodes a coded signal which has been inputted, to produce audio data.

A video processing circuit 5 receives video data from the AV decoder 4 and subjects the received video data to digital-to-analog (D/A) conversion, to generate a video signal. An audio processing circuit 6 receives the audio data outputted from the AV decoder 4 and subjects the received audio data to digital-to-analog (D/A) conversion, to generate an analog signal of a right (R) sound and an analog signal of a left (L) sound.

An OSD (On-Screen Display) circuit 11 outputs to an adder 20 bit map data based on character information or color information which it is instructed to output from the CPU 12. The adder 20 incorporates a video signal based on the bit map data into the video signal outputted from the video processing circuit 5, and feeds the video signal to a drive circuit 7. By the OSD circuit 11, display of an EPG based on the above-mentioned program information received by the CPU 12, and display of a menu screen, a reserved program list screen, a series reservation list screen, a transition screen at the time of series reservation, and so forth can be performed.

A CRT(Cathode-Ray Tube) 8 displays video by a video signal (an R, G, and B signal and a vertical and horizontal synchronizing signal) fed from the drive circuit 7. Further, a speaker 14 outputs audio by an audio signal outputted from the audio processing circuit 6.

A remote control transmitter 9 is a transmitter for sending out a command to the broadcasting receiver 30. When a key (not shown) provided in the remote control transmitter 9 is operated, signal light (a remote control signal) meaning a command corresponding to the key is sent out from a light emitter (not shown). A remote control light receiver 10 receives the signal light, converts the received signal light into an electric signal, and feeds the electric signal to the CPU 12. A user can perform operations such as selection and determination of items such as the menu screen, the EPG screen, and the series reservation list screen and programs using the remote control transmitter 9.

A memory (RAM, EEPROM, Flash Memory, etc.) 13 stores re-retrieval time setting information, etc. in addition to data (program information, etc.) for displaying the EPG screen, the menu screen, the reserved program list screen, the series reservation list screen, and so forth.

Although the CPU 12 carries out overall control in the digital broadcasting receiver 30, series reservation control, described below, is particularly carried out as control according to the present invention.

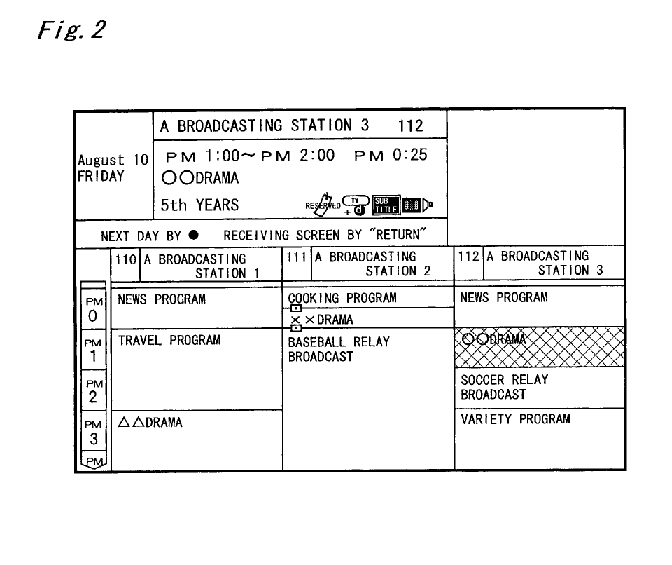

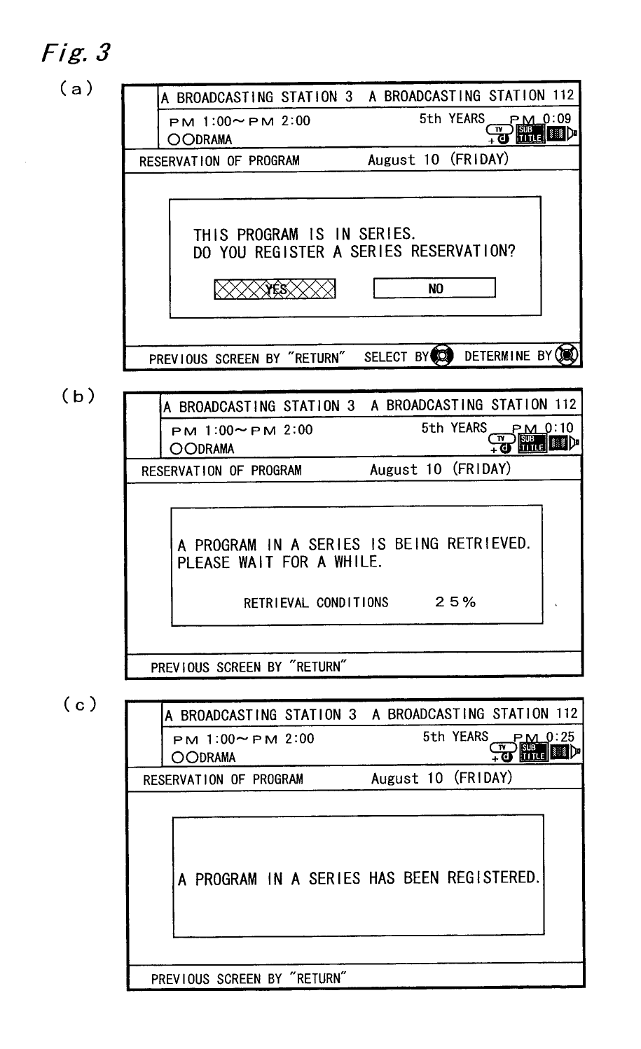

FIG. 2 illustrates an EPG screen for the 10-th of August. The user can reserve a desired program on the EFG screen. The user operates the key provided in the remote control transmitter 9, and selects a program which is desired to be reserved to perform reservation processing. If it is assumed that the user selects a ◯◯ drama, the CPU 12 judges whether or not program information related to the ◯◯ drama has series_id, displays, when it has series_id, a message saying “This program is in a series. Do you register the program as a series reservation?”, as shown in FIG. 3 (a), to prompt the user to choose whether or not a series reservation is executed. The user operates the remote control transmitter 9, thereby making it possible to transmit an intention as to whether or not a series reservation is executed to the receiver 30 using a button “YES” or “NO”.

When the user selects “YES” in FIG. 3 (a), the CPU 12 performs processing such as retrieval of a program having the same series_id as that of the above-mentioned ◯◯ drama in the program information currently held in the memory 13 and acquisition of episode_number (setting of the number of episodes before the final episode) in a case where the program has series_id, and displays a message saying “A program in a series is being retrieved. Please wait for a while.”, as shown in FIG. 3 (b), on a screen while the processing is being performed. Further, a ratio at which the retrieval is completed, for example, “25%” is displayed as retrieval conditions. Consequently, the user can estimate a time period required until the retrieval is substantially terminated.

When the retrieval of the program in the series is terminated, a message saying “Programs in a series have been registered.”, as shown in FIG. 3 (c). Consequently, the user knows that the registration of the series reservation is completed with respect to the ◯◯ drama.

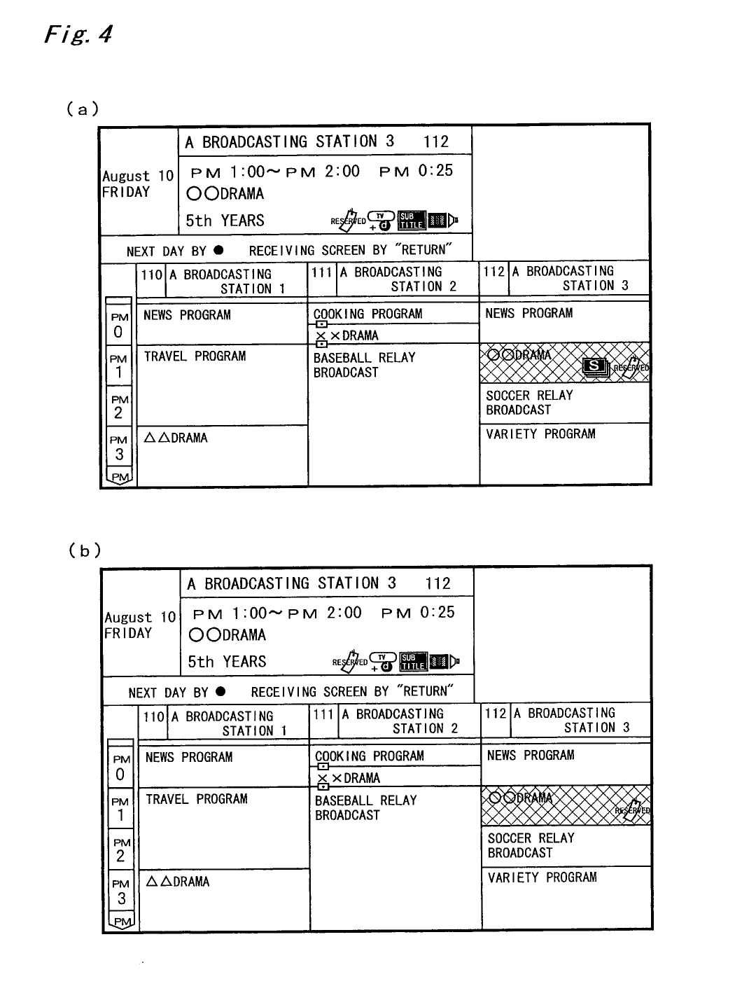

When the series reservation is registered, a mark indicating that a reservation is registered as a series is displayed on a display area of the ◯◯ drama on the subsequent EPG screen, as shown in FIG. 4 (a), for example. On the other hand, when the user selects “NO” in response to a inquiry as to whether or not the above-mentioned series reservation is executed, the CPU 12 registers the reservation of only the corresponding program. In this case, a mark indicating that a reservation is merely registered is displayed in the display area of the ◯◯ drama on the subsequent EPG screen, as shown in FIG. 4 (b), for example. It goes without saying that such a distinction is not made on the EPG screen.

Processing such as retrieval of a program having the same series_id as that of the above-mentioned ◯◯ drama from the program information held by the memory 13 and acquisition of episode_number in a case where the program has series_id is performed not only at the time point where the above-mentioned registration of the series is selected by the user but also at regular or irregular intervals after that. This processing is referred to as re-retrieval.

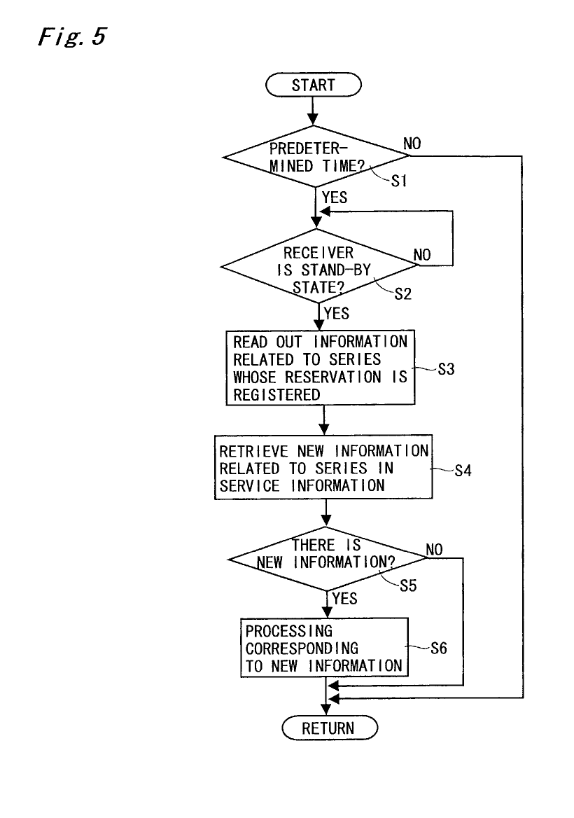

FIG. 5 is a flow chart showing the contents of processing at the time of the re-retrieval. Here, a predetermined time (e.g., 4:00 a.m.) shall be previously set as the time when re-retrieval is performed in the broadcasting receiver 30. The CPU 12 judges, when the current time becomes the above-mentioned predetermined time (YES at step S1), whether the broadcasting receiver 30 is in a stand-by state (TV is turned off) or not(TV is turned on) (step S2). When the broadcasting receiver 30 is not in a stand-by state, the subsequent processing shall be continued when the broadcasting receiver 30 then enters a stand-by state. When the broadcasting receiver 30 is in a stand-by state, the CPU 12 reads out program information related to a series, whose reservation has been registered as a series, from the memory 13 (step S3), and retrieves new information with respect to the series (step S4). The CPU 12 performs, when there is new information (YES at step S5), various types of processing corresponding to the information (step S6). Examples of various types of processing include reservation processing for a new program constituting the series in program information acquired after that, processing in a case where there is no program constituting the series which is scheduled to be broadcast, and processing performed in a case where the reserved program is overlapped with the other reserved program. The processing will be described later.

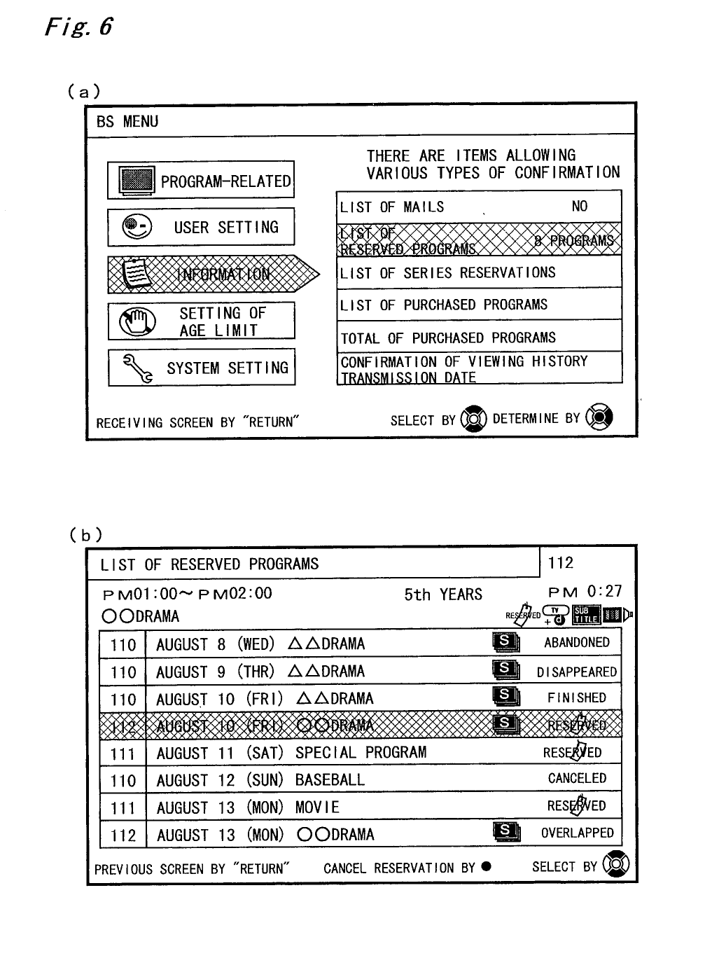

FIG. 6 (a) illustrates a menu screen. On this screen, a state where an item “information” is selected, low-order items “a list of mails”, “a list of reserved programs”, “a list of series reservations”, etc. are correspondingly displayed, and the item “list of reserved programs” is selected is illustrated. When a user performs determination processing in this state, a reserved program list screen is displayed, as shown in FIG. 6 (b). On this reserved program list screen, a normal reserved program and a program constituting a series, which has been reserved as a series, are displayed as a mixture. To the program constituting the series, an “S” mark indicating that a program is in a series is attached. Further, the programs are listed in the order in which they are broadcast.

The user can operate the remote control transmitter 9, select the arbitrary reserved program on the reserved program list screen, and press a button set for reservation cancellation to cancel the reservation. The CPU 12 performs, when the program whose reservation has been canceled is a program constituting a series, processing for canceling the reservation of only the program in the series. At this time, the CPU 12 performs processing for excluding the program constituting the series, whose reservation has been canceled, from an object to be reserved. However, the CPU 12 does not delete information related to the program constituting the series but stores in the memory 13 the fact that the reservation has been canceled. Information indicating that the reservation has been canceled is used, thereby making it possible to prevent the program whose reservation has been canceled from being reserved again by re-retrieval. Further, a note “canceled” is displayed on the program whose reservation has been canceled, which shows that the reservation of the program constituting the series has been canceled.

On the reserved program list screen, notes “abandoned”, “finished”, “disappeared”, “reserved”, or “overlapped” are displayed in addition to the above-mentioned note “canceled” with respect to each of the programs. The note “abandoned” is given to the reserved program, whose reservation has not been executed, because a main power supply to the receiver 30 is turned off, for example, at the time point where the reservation is executed. The note “finished” is given to the reserved program whose reservation has been executed. The note “disappeared” is given when the program which is scheduled to be broadcast is not broadcast due to circumstances on the side of a broadcasting station, and this is found by the re-retrieval. The note “reserved” is given in the step before executing the reservation, and is changed to “finished”, “disappeared”, and “abandoned” when the time point where the reservation is executed has elapsed.

The note “overlapped” is given, when another program (including a program constituting another series) has already been reserved with the program overlapped with the air time of a program constituting a series, which has been reserved as a series, with respect to the program constituting the series. Specifically, the CPU 12 judges whether or not another program has already been reserved with the program overlapped with the air time of a program constituting a series, which has been reserved as a series, and displays, when it judges that the program has been reserved with the program overlapped with the air time of the program constituting the series, “overlapped” in a display area of the program constituting the series on the reserved program list screen. As to which of the two programs which are overlapped with each other should be given priority as an object to be reserved, the program which is not in the series is given priority, the program which is in the series is given priority, the program whose reservation is earlier is given priority, and the program, which has been reserved earlier as a series, if both the programs are in the series, is given priority, for example. Further, the user may be caused to select any of them. The reservation of the program which is given priority is executed, but the reservation of the program which is not given priority is not executed.

The existence of the overlapped programs can be found out by retrieval at the time point where series registration is selected by the user, and may, in some cases, be also found out by the subsequent re-retrieval. On the other hand, there is a case where the programs are overlapped with each other in the retrieval at the time point where series registration is selected by the user, but the overlapped state is solved at the time point of the re-retrieval by the subsequent change in a schedule for broadcasting. The CPU 12 registers, when the overlapped state is solved, the reservation of the program constituting the series, and performs processing for changing “overlapped” in the display area of the program to “reserved”.

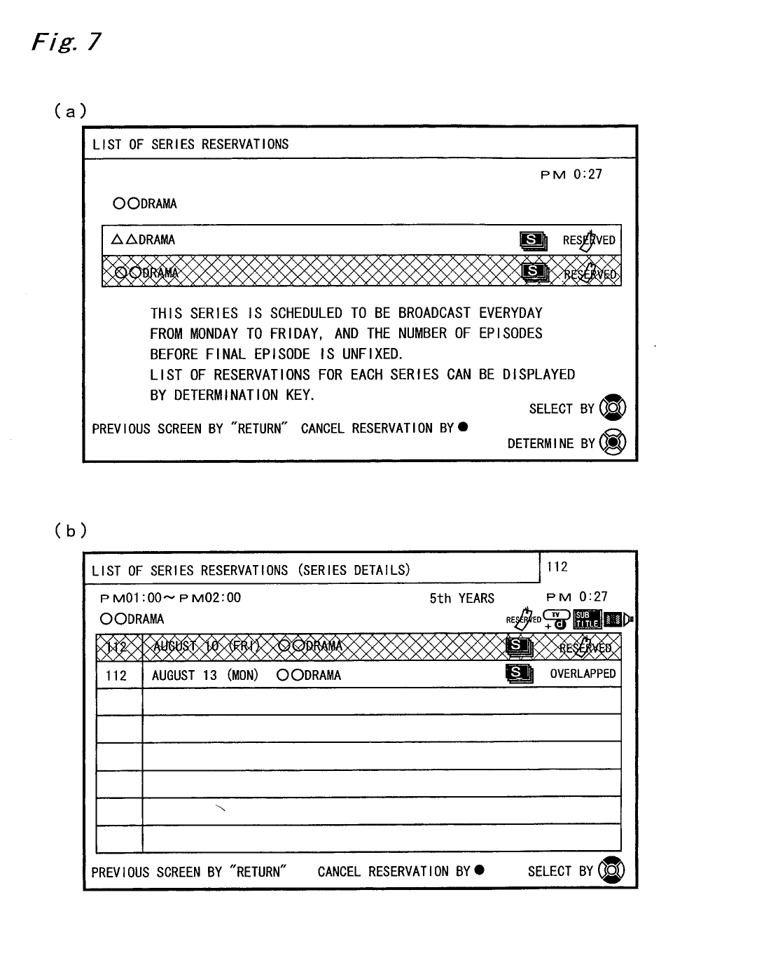

FIG. 7 illustrates a series reservation list screen having only series as an object. The series reservation list screen shown in FIG. 7 (a) is displayed by selecting a series reservation list display item (button) on the menu screen shown in FIG. 6 (a). On the series reservation list screen, information related to the selected series is displayed. When the user operates a key provided in the remote control transmitter 9, to select a ◯◯ drama, for example, the CPU 12 reads out information related to the ◯◯ drama from the memory 13, produces a message, and displays the produced message on the screen, as illustrated. Examples of the message to be displayed include “This series is scheduled to be broadcast every day from Monday to Friday, and the final episode has been unfixed.” and “This series is irregular. ” The information can be known by a description representing an organization pattern in a series descriptor or a description indicating how many episodes are there before the final episode. Further, the user can operate the remote control transmitter 9 on the series reservation list screen to select a desired series, and press a button set for reservation cancellation to cancel the whole of the series. When the drama is selected to perform cancellation, the drama is not an object to be retrieved at the time of the subsequent re-retrieval.

FIG. 7 (b) illustrates a reserved program list (series constituting program display) screen appearing when the ◯◯ drama is selected to operate a determination key on the screen shown in FIG. 7 (a). The user can obtain information related to the date on which broadcasting of each of the programs constituting the series is started, for example, by the reserved program list screen. Further, notes “disappeared”, “canceled”, “abandoned”, “finished”, “reserved”, and “overlapped” are displayed on the reserved program list screen. The display processing of the notes can be performed in the same manner as that in the case of the reserved program list screen shown in FIG. 6 (b).

The series descriptor includes a descriptor which can be used for judging the termination of a series, which makes it possible to recognize the termination of the series in the receiver 30. Even if processing for reserving the final program constituting the series is completed, however, re-retrieval may be performed until the time point where the reservation is executed.

Execution of re-retrieval (judgment of disappearance or overlapping) and confirmation of abandonment or termination may be carried out at least once per day. An example of unscheduled execution timing in a case where the execution of re-retrieval and the confirmation of abandonment or termination are carried out a plurality of times per day is conceivably the timing at which the state of the receiver 30 is changed to a stand-by state (TV is turned off). However, there are further several processing which should be performed when the receiver 30 is in a stand-by state. When the execution of re-retrieval and the confirmation of abandonment or termination are carried out once per day, processing which is not performed at the other time points where the receiver 30 enters a stand-by state on the day may be employed in view of the other processing The reason is that it is considered that information related to the series is hardly updated again in a day. In the example of the processing shown in FIG. 5, it is judged whether or not the receiver 30 is in a stand-by state after the set time has come. In such processing, the execution of re-retrieval and the confirmation of abandonment or termination are carried out at regular intervals once per day. When the receiver 30 is not in a stand-by state at the time point where the set time has come, however, the execution of re-retrieval and the confirmation of abandonment or termination are carried out with some time lag (at the time when the receiver 30 subsequently enters a stand-by state). Although it is desirable that the time when re-retrieval is performed is the time when the user hardly performs viewing, it can be also 0:00 a.m. (the time point where the date changes). Further, the receiver 30 may be so constructed that the time when re-retrieval is performed is not fixedly set on the side of the receiver but can be designated by the user. Even in a case where the user designates the time, when the receiver 30 is not in a stand-by state at the time point, the execution of re-retrieval and the confirmation of abandonment or termination may be carried out with some time lag (at the time when the receiver 30 subsequently enters a stand-bay state). If a CPU which is very high in processing capability, for example, is used, re-retrieval processing can be performed even if the receiver 30 is not in a stand-by state.

As described in the foregoing, the digital broadcasting receiver according to the present invention produces the effect of providing convenience to a user by performing various types of processing using series as an object.

Although in the above-mentioned embodiment, a case where the digital broadcasting receiver is a television set containing a digital tuner is illustrated, it may be configured as a set top box.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A digital broadcasting receiver characterized by comprising:
means for extracting program information included in a digital broadcasting wave;
means for outputting a program guide table on the basis of said program information;
means for judging, when a program is reserved by a user on said program guide table, whether or not the reserved program is in a series on the basis of said program information, to prompt, when the reserved program is in the series, the user to choose whether or not the reserved program should be registered as a series reservation; and
means for extracting, when it is chosen that the reserved program should be registered as a series reservation, programs which are in a series relationship with said reserved program on the basis of said program information, to process the programs constituting the series as reserved programs.

2. In the digital broadcasting receiver according to claim 1, a digital broadcasting receiver characterized in that
a list of reserved programs can be displayed, to display a note meaning a series on a display area of the program constituting the series on the list of reserved programs.

3. In the digital broadcasting receiver according to claim 1 or 2, a digital broadcasting receiver characterized in that
a list of reserved programs can be displayed, to handle, when reservation cancellation processing of the program constituting the series is performed on the list of reserved programs, the reservation cancellation processing as cancellation of only the program constituting the series, record that the program constituting the series is canceled without being deleted as data related to the series, and display on the list of reserved programs a note meaning that a program has been canceled.

4. In the digital broadcasting receiver according to any one of claims 1 to 3, a digital broadcasting receiver characterized in that
a list of series reservations using only series as an object can be displayed.

5. In the digital broadcasting receiver according to claim 4, a digital broadcasting receiver characterized in that
when the series is selected on the list of series reservations,
an explanatory note based on information acquired from said program information is displayed with respect to the series.

6. In the digital broadcasting receiver according to claim 4 or 5, a digital broadcasting receiver characterized in that
when the series is selected on the list of series reservations to perform a predetermined operation,
the list of reserved programs comprising the programs constituting the series is displayed.

7. In the digital broadcasting receiver according to any one of claims 4 to 6, a digital broadcasting receiver characterized in that
when reservation cancellation processing of the series is performed on the list of series reservations,
the processing is performed as reservation cancellation of all the programs constituting the series

8. In the digital broadcasting receiver according to any one of claims 1 to 7, a digital broadcasting receiver characterized in that
it is judged whether or not another program which is overlapped with the air time of the program constituting the series, which has been reserved as a series, has already been reserved, to display, when it is judged that the program has been reserved in an overlapped state, a note meaning overlapping in the display area of the program constituting the series on the list of reserved programs.

9. In the digital broadcasting receiver according to any one of claims 1 to 8, a digital broadcasting receiver characterized in that
processing for retrieving the program constituting the series from the program information again is repeatedly performed at regular or irregular intervals.

10. In the digital broadcasting receiver according to claim 9, a digital broadcasting receiver characterized in that
when the program constituting the series, which is an object to be reserved, is deleted from a schedule of broadcasting before the reservation thereof is executed,
the reservation of the program constituting the series is not executed, to display a note meaning that a schedule of broadcasting is deleted before the reservation is executed in the display area of the program constituting the series on the list of reserved programs.

11. In the digital broadcasting receiver according to claim 8, a digital broadcasting receiver characterized in that
processing for retrieving the program constituting the series from the program information again is repeatedly performed at regular or irregular intervals, to register, when the overlapped state is solved in the re-retrieval, the reservation of the program constituting the series as well as to delete the note meaning overlapping from the display area of the program constituting the series on the list of reserved programs.

12. In the digital broadcasting receiver according to any one of claims 9 to 11, a digital broadcasting receiver characterized in that
processing for retrieving the program constituting the series from the program information again is performed at least once per day.
